(19) United States
(12) Patent Application Publication
(10) Pub. No.: US 2007/0270040 A1
(43) Pub. Date: Nov. 22, 2007

(54) Chamfered Memory Card

(76) Inventors: Sang Jae Jang, Gwangjin-gu (KR); Chul Woo Park, Gangdong-gu (KR); Jong Woon Choi, Nowon-gu (KR); Jae Dong Kim, Gwangjin-gu (KR); Choon Heung Lee, Gwangju-si (KR)

Correspondence Address: STETINA BRUNDA GARRED & BRUCKER, 75 ENTERPRISE, SUITE 250, ALISO VIEJO, CA, 92656, US

(21) Appl. No.: 11/381,877

(22) Filed: May 5, 2006

(51) Int. Cl. H01R 24/00

(52) U.S. Cl. 439/660

(57) ABSTRACT

A memory card including a printed circuit board having an electronic circuit device mounted thereto and at least one I/O pad disposed thereon. The printed circuit board and the electronic circuit device are at least partially encapsulated or covered by an encapsulant material which hardens into a body of the memory card, such body generally defining the outer appearance of the memory card. The I/O pads of the printed circuit board are exposed in the body. The body is formed to include one or more chamfers. Such chamfer(s) are sized and configured to minimize potential damage to the connection terminals or host socket of a device during the process of interfacing the memory card thereto.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND OF THE INVENTION

1. Field of the Invention

The present invention relates generally to memory cards, and more particularly to a memory card (e.g., a multi-media card or secure digital card) comprising a fully molded encapsulant body which is formed to include on or more chamfers specifically configured such that the host socket connector pins of a host socket are not damaged by the repeated advancement of the memory card into the host socket.

2. Description of the Related Art

As is well known in the electronics industry, memory cards are being used in increasing numbers to provide memory storage and other electronic functions for devices such as digital cameras, MP3 players, cellular phones, and personal digital assistants. In this regard, memory cards are provided in various formats, including multi-media cards and secure digital cards.

Many memory cards include a module which itself comprises a printed circuit board (PCB) having a conductive wiring pattern disposed thereon. Attached to one side or surface of the PCB and electrically connected to the conductive pattern thereof is a plurality of electronic circuit devices, such as semiconductor packages, semiconductor dies, and/or passive elements. These electronic circuit devices and a portion of the PCB are often covered or encapsulated by an encapsulant material. The PCB also includes a plurality of input/output (I/O) pads disposed on the side or surface thereof opposite that having the electronic circuit devices thereon. These I/O pads are not covered by the encapsulant material, and thus are exposed in the completed module which comprises the PCB, the electronic circuit devices and the encapsulant material. Attached to the module is a skin or case of the memory card, such case generally defining the outer appearance of the memory card. The module is coupled to the case such that the I/O pads disposed on the PCB are not covered by the case, and thus remain exposed in the fully assembled memory card. These I/O pads of the memory card provide an external interface for an insertion point or socket. The completed memory card has a generally rectangular configuration, with most memory cards including a chamfer formed at one edge thereof which is adjacent to the I/O pads. In an effort to simplify the process steps needed to fabricate the memory card, there has been developed various memory cards wherein the case is eliminated by applying the encapsulant material the electronic devices and to the PCB such that the enapsulant material hardens into a cover or body of the memory card which is sized and configured to meet or achieve a desired “form factor” for the memory card.

Memory cards, such as multi-media cards, are used by advancing the same into a host socket which includes a plurality of connector pins. One deficiency of currently known fully molded memory cards (i.e., memory cards which do not include a separate case) is that the leading edge of the body thereof is typically fabricated to define a corner which is angled at approximately ninety degrees. This sharp corner, provided on a body typically fabricated from a material significantly harder than general plastic products, often results in some measure of damage to the device into which the memory card is inserted. Such damage is typically evident over time after repeated cycles of the insertion of the memory card into the host socket of the device, the damage often occurring as a result of the contact or rubbing of the sharp leading edge of the memory card against the device. Because of this damage causing potential, in molded memory cards such as MMC micro, Micro SD (secure digital) and SIM (subscriber identity module) cards, regulations call for a chamfer of predetermined size to be included on the leading edge of the card for purposes of preventing damage to the connection terminal or host socket of the device with which the card is to be used. In accordance with currently known manufacturing processes, such chamfer is formed via a bevel saw or routing process subsequent to the formation of the body through the molding process described above. The need to complete this separate chamfer forming process necessarily increases the production costs associated with the memory card. In addition, spherical fillers which are often included in the encapsulant material used to form the body may be partially cut and exposed in the chamfered surface, thus creating undesirable flakes. These flakes may themselves damage the connection terminals/host socket when the memory card in used therewith.

The present invention addresses and overcomes this deficiency of currently known fully molded memory cards by providing a memory card wherein the memory card body is formed to include one or more chamfered leading edges adapted to prevent damage to any device including a host socket into which the memory card is advanced. These and other attributes of the present invention will be described in more detail below.

### BRIEF SUMMARY OF THE INVENTION

In accordance with the present invention, there is provided multiple embodiments of a memory card, each embodiment including a printed circuit board having an electronic circuit device mounted thereto and at least one I/O pad disposed thereon. The printed circuit board and the electronic circuit device are at least partially encapsulated or covered by an encapsulant material which hardens into a body of the memory card, such body generally defining the outer appearance of the memory card. The I/O pads of the printed circuit board are exposed in the body. The body is formed to include one or more chamfers. Such chamfer(s) may be formed to have any one of a variety of different configurations, each such configuration being particularly suited to minimize potential damage to the connection terminals or host socket of a device during the process of interfacing the memory card thereto. Further in accordance with the present invention, there is provided a method of fabricating a memory card having the aforementioned structural attributes.

The present invention will be more apparent from the following detailed description taken in conjunction with the accompanying drawings.

### BRIEF DESCRIPTION OF THE DRAWINGS

FIG. 1a is a top perspective view of a memory card constructed in accordance with a first embodiment of the present invention;

FIG. 1b is a bottom perspective view of the memory card shown in FIG. 1a;

FIG. 1c is a cross-sectional view taken along line A-A of FIG. 1a;

FIG. 1d is an enlargement of the encircled region A shown in FIG. 1c;

FIG. 2a is a top perspective view of a memory card constructed in accordance with a second embodiment of the present invention;

FIG. 2b is a bottom perspective view of the memory card shown in FIG. 2a;

FIG. 2c is a front elevational view of the memory card shown in FIG. 2a;

FIG. 3a is a top perspective view of a memory card constructed in accordance with a third embodiment of the present invention;

FIG. 3b is a bottom perspective view of the memory card shown in FIG. 3a;

FIG. 3c is a front elevational view of the memory card shown in FIG. 3a;

FIG. 4a is a top perspective view of a memory card constructed in accordance with a fourth embodiment of the present invention;

FIG. 4b is a bottom perspective view of the memory card shown in FIG. 4a;

FIG. 4c is a cross-sectional view taken along line B-B of FIG. 4a;

FIG. 5 is a flow chart describing an exemplary sequence of steps which may used to facilitate the fabrication of a memory card in accordance with any embodiment of the present invention;

FIGS. 6a-6d illustrate an exemplary sequence of steps which may used to facilitate the fabrication of the memory card shown in FIGS. 1a-1d;

FIG. 7 is a top plan view of multiple circuit board assembly which may alternatively be used in the process shown in FIGS. 6a-6d; and

FIGS. 8a-8b illustrate an exemplary sequence of steps which may used to facilitate the fabrication of the memory card shown in FIGS. 4a-4c.

Common reference numerals are used throughout the drawings and the detailed description to indicate the same elements.

### DETAILED DESCRIPTION OF THE INVENTION

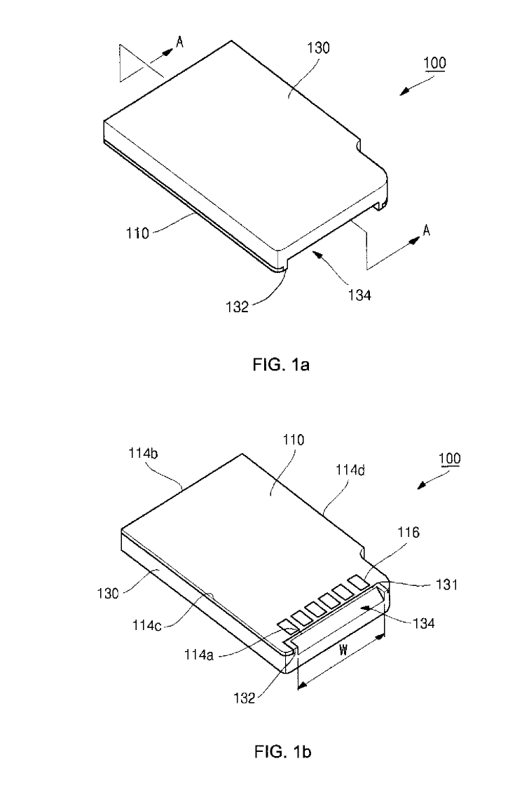

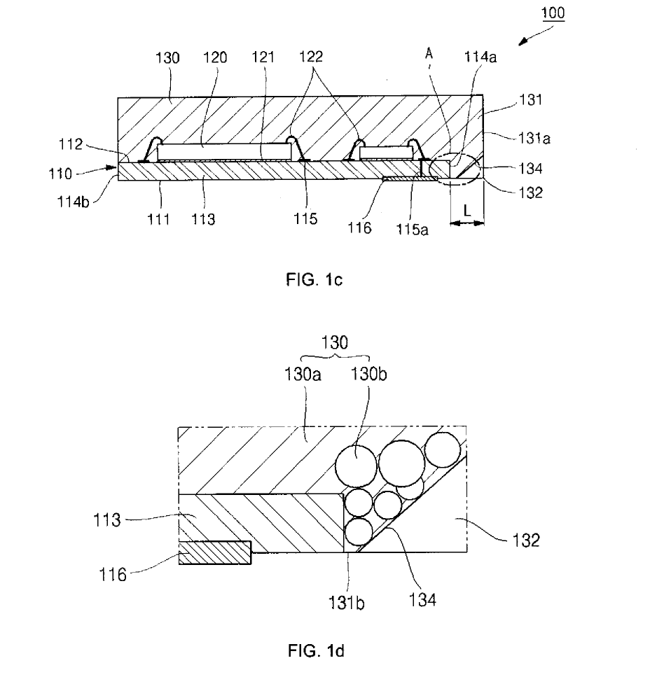

Referring now to the drawings wherein the showings are for purposes of illustrating preferred embodiments of the present invention only, and not for purposes of limiting the same, FIGS. 1a-1d depict a memory card 100 constructed in accordance with a first embodiment of the present invention. The memory card 100, as well as the memory cards of other embodiments of the present invention which will be described in more detail below, may be a multi-media card (MMC), a reduced size multi-media card (RSMMC), a secure digital (SD) card, a micro multi-media card (micro MMC), a micro secure digital card (micro SD), or a subscriber identity module (SIM) card.

The memory card 100 includes a printed circuit board 110. The circuit board 110 itself includes an insulative layer 113 defining a generally planar lower surface 111 and an opposed, generally planar upper surface 112. Formed on the lower surface 111 of the insulative layer 113 in close proximity to one of the peripheral edge segments thereof is a plurality of input/output (I/O) pads 116. The insulative layer 113 has a generally quadrangular (e.g., rectangular) configuration defining a laterally extending front side 114a, an opposed laterally extending back side 114b, and an opposed pair of longitudinally extending sides 114c, 114d which extend generally perpendicularly from the back side 114b. The I/O pads 116 extend along and in close proximity to the front side 114a of the insulative layer 113. Formed on the upper surface 112 of the insulative layer 113 is a conductive pattern 115 which is placed into electrical communication with the I/O pads 116 on the lower surface 111 through a conductive medium formed through and/or upon the insulative layer 113. Such conductive medium may include conductive vias 115a (as shown in FIG. 1c) which extend through the insulative layer 113. The circuit board 110 can be a hardened printed circuit board, a flexible printed circuit board, or any equivalent thereto, the present invention not being restricted to any particular type of circuit board 110.

Mounted to the upper surface 112 of the insulative layer 113 of the circuit board 110 is an electronic circuit device 120. The mounting of the electronic circuit device 120 to the circuit board 110 is preferably facilitated by a layer 121 of a suitable adhesive. As best seen in FIG. 1c, the electronic circuit device 120 comprises a pair of semiconductor dies which are each electrically connected to the conductive pattern 115 formed on the upper surface 112 through the use of conductive wires 122. A flip chip interconnection may also be employed to facilitate the electrical connection of the electronic circuit device 120 to the conductive pattern 115 of the circuit board 110. As will be recognized, the conductive pattern 115 and/or conductive vias 115a of the circuit board 110 may be used to facilitate the placement of the electronic circuit device 120 into electrical communication with the I/O pads 116 in any desired pattern or arrangement. Those of ordinary skill in the art will recognize that rather than comprising only the semiconductor dies, the electronic circuit device 120 may comprise a semiconductor die or a semiconductor package alone or in combination with various passive devices (e.g., a resistor and/or a condenser), or may include flash memory semiconductors and control semiconductors incorporating control logic. Further, it is contemplated that one or more components of the electronic circuit device 120 can be vertically stacked. In this regard, the type, number and arrangement of the components included in the electronic circuit device 120 may be selectively varied depending on the desired application for the memory card 100. All that is necessary is that the circuit board 110 be configured to facilitate the electrical communication between any such component(s) and the I/O pads 116 in a prescribed manner. Along these lines, the number of I/O pads 116 included in the circuit board 110 is also variable, in that the number of such I/O pads 116 may be varied according to the particular application for the memory card 100.

In the memory card 100, the electronic circuit device 120, the upper surface 112 of the insulative layer 113 including the conductive pattern 115, and the conductive wires 122 are covered by a layer of encapsulant material which hardens into a body 130 of the memory card 100. The body 130 also covers the front side 114a of the insulative layer 113. The encapsulant material used to form the body 130 preferably comprises a resin 130a (which constitutes a base) having fillers 130b uniformly dispersed or distributed therein. The body 130 includes a frontal portion 131 which covers the front side 114a of the insulative layer 113 and extends generally perpendicularly therefrom to a predetermined length L shown in FIG. 1c. The frontal portion 131 itself defines a generally planar, laterally extending front side surface 131a of the body 130 which forms the leading edge of the memory card 100. The front side surface 131a extends generally perpendicularly between opposed, generally planar top and bottom surfaces of the body 130, a corner 132 having an angle of approximately ninety degrees (90°) thus being defined between the front side 131a and the bottom surface 131b of the body 130. The body 130 further defines a laterally extending, generally planar back side surface which is substantially flush or continuous with the back side 114b of the insulative layer 113, and an opposed pair of longitudinally extending, generally planar side surfaces which are substantially flush with respective ones of the longitudinally extending sides 114c, 114d of the insulative layer 113. In the memory card 100, the height of the body 130 (i.e., the distance separating the top surface of the body 130 from the upper surface 112 of the insulative layer 113) is predetermined according to the height of the electronic circuit device 120 encapsulated by the body 130.

Formed in the frontal portion 131 of the body 130 is a beveled edge or chamfer 134. The chamfer 134 is formed in the corner 132 and is of a preferred predetermined width W (as shown in FIG. 1b). The preferred width W of the chamfer 134 is roughly equal to the distance separating the outermost sides of the outermost pair of the I/O pads 116. Additionally, the preferred angle of the chamfer 134 may be varied in accordance with the scope of the specifications for the memory card 100, and need only comply with any regulations corresponding to the memory card 100. When the memory card is mounted to an external device (not shown), the chamfer 134 guides the connection terminals of the external device in such a manner as facilitates smooth contact with the corresponding I/O pads 116, thus minimizing potential damage to the host device.

As will be discussed in more detail below, the chamfer 134 is formed simultaneously with the body 130 during the process of molding the body 130 through the use of a suitable mold. As a result, the formation of the chamfer 134 does not involve the completion of any separate bevel saw or routing procedure. Because the chamfer 134 is formed during the body 130 molding process and not by sawing or routing, any fillers 130b extending to the chamfer 134 maintain their generally spherical configurations and do not give rise to undesirable flaking since they are not cut.

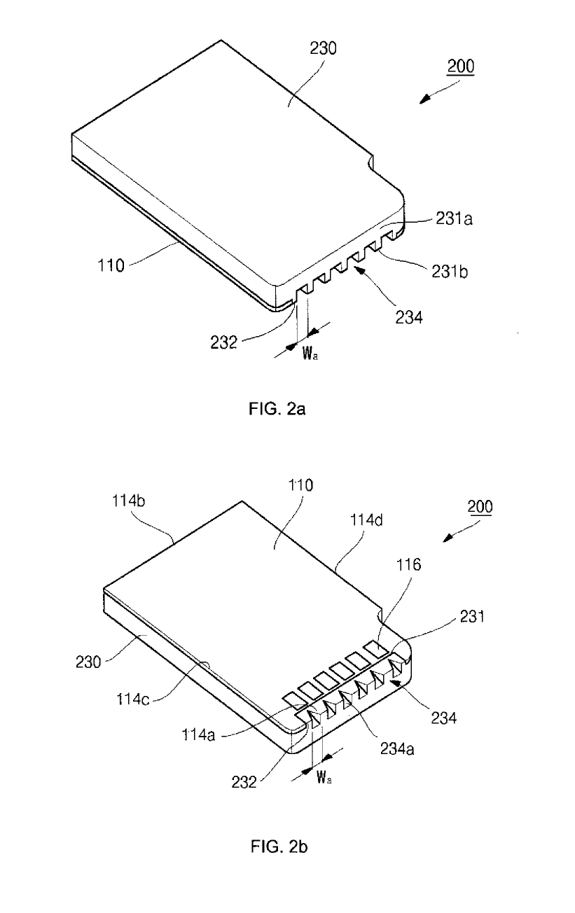

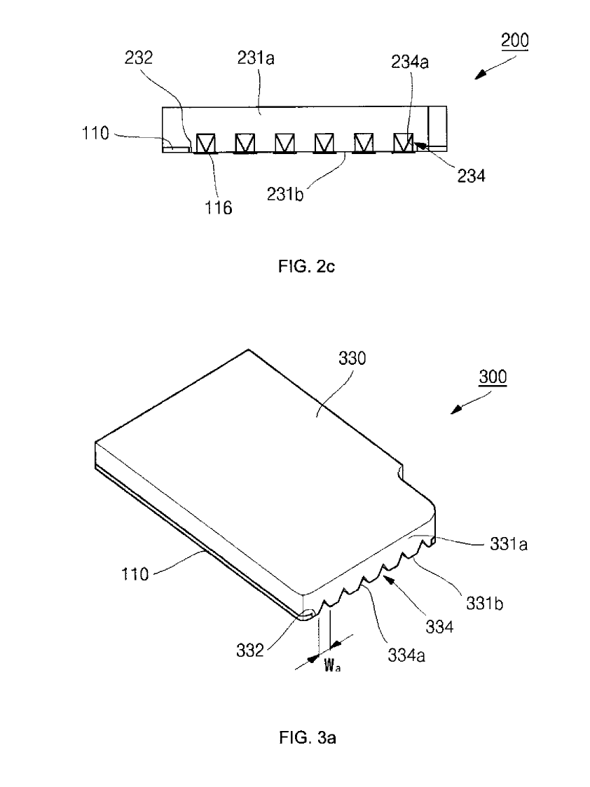

Referring now to FIGS. 2a-2c, there is shown a memory card 200 constructed in accordance with a second embodiment of the present invention. The memory card 200 of the second embodiment bears substantial similarity in construction to the memory card 100 of the first embodiment, with the 200 series reference numerals in FIGS. 2a-2c being used to identify the same structures identified by the corresponding 100 series reference numerals included in FIGS. 1a-1d. In this regard, only the distinctions between the memory cards 200, 100 will be discussed below.

In the memory card 200 of the second embodiment, the above-described chamfer 134 is substituted with a chamfer 234 which comprises a plurality of sub-chamfers 234a. Those of ordinary skill in the art will recognize that the term “sub-chamfers” as used in relation to the memory card 200 as well as other embodiments of the memory card which will be discussed below is intended to encompass structures such as channels, slots and grooves. Each of the sub-chamfers 234a is formed in the corner 232 of the body 230, and extends from the front side surface 231a of the body 230 toward a respective one of the I/O pads 116. In this regard, the number of sub-chamfers 234a included in the memory card 200 corresponds to the number of I/O pads 116 thereof, each sub-chamfer 234a extending toward a respective one of the I/O pads 116. As seen in FIGS. 2a-2c, each of the sub-chamfers 234a is preferably of a width Wa at the front side surface 231a which is approximately identical to the lateral width of the corresponding I/O pad 116. The width of each sub-chamfer 234a gradually decreases as it extends toward the corresponding I/O pad 116. Thus, each sub-chamfer 234a has a generally square shape when viewed from the front side surface 231a of the body 230, and a generally triangular shape when viewed from a bottom surface 231b of the body 230. The spacing or intervals between the sub-chamfers 234a corresponds to the spacing or intervals between the I/O pads 116, with the distance separating the outermost sides of the outermost pair of sub-chamfers 234a from each other being substantially identical to the distance separating the outermost sides of the outermost pair of the I/O pads 116 from each other. Advantageously, the sub-chamfers 234a guide the connection terminals of an external device with which the memory card is used in a manner wherein such connection terminals contact the I/O pads 116 in a more accurate manner.

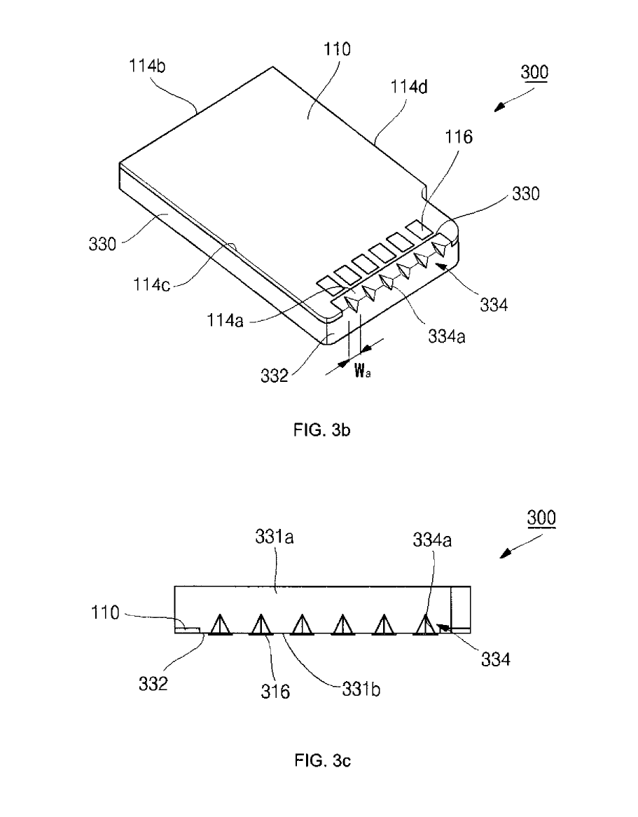

Referring now to FIGS. 3a-3c, there is shown a memory card 300 constructed in accordance with a third embodiment of the present invention. The memory card 300 of the third embodiment bears substantial similarity in construction to the memory cards 100 and 200 of the first and second embodiments, with the 300 series reference numerals in FIGS. 3a-3c being used to identify the same structures identified by the corresponding 100 and 200 series reference numerals included in FIGS. 1a-1d and in FIGS. 2a-2c, respectively. In this regard, only the distinctions between the memory cards 300, 200 will be discussed below.

Like the memory card 200 of the second embodiment, the memory card 300 of the third embodiment includes a chamfer 334 which comprises a number of sub-chamfers 334a, in contrast to the single chamfer 134 of the memory card 100 of the first embodiment. As indicated above, the term “sub-chamfers” as used in relation to the memory card 300 is intended to encompass structures such as channels, slots and grooves. Each of the sub-chamfers 334a is formed in the corner 332 of the body 330, and extends from the front side surface 331a of the body 330 toward a respective one of the I/O pads 116. In this regard, the number of sub-chamfers 334a included in the memory card 300 corresponds to the number of I/O pads 116 thereof, each sub-chamfer 334a extending toward a respective one of the I/O pads 116. As seen in FIGS. 3a-3c, each of the sub-chamfers 334a is preferably of a maximum width Wa at the corner 332 which is approximately identical to the lateral width of the corresponding I/O pad 116. In this regards, each sub-chamfer 234a has a generally triangular shape when viewed from the front side surface 331a of the body 330, and also has a generally triangular shape when viewed from a bottom surface 331b of the body 330. The spacing or intervals between the sub-chamfers 334a corresponds to the spacing or intervals between the I/O pads 116, with the distance separating the outermost corner of the outermost pair of sub-chamfers 334a from each other being substantially identical to the distance separating the outermost sides of the outermost pair of the I/O pads 116 from each other. Advantageously, the sub-chamfers 334a guide the connection terminals of an external device with which the memory card is used in a manner wherein such connection terminals contact the I/O pads 116 in a more accurate manner.

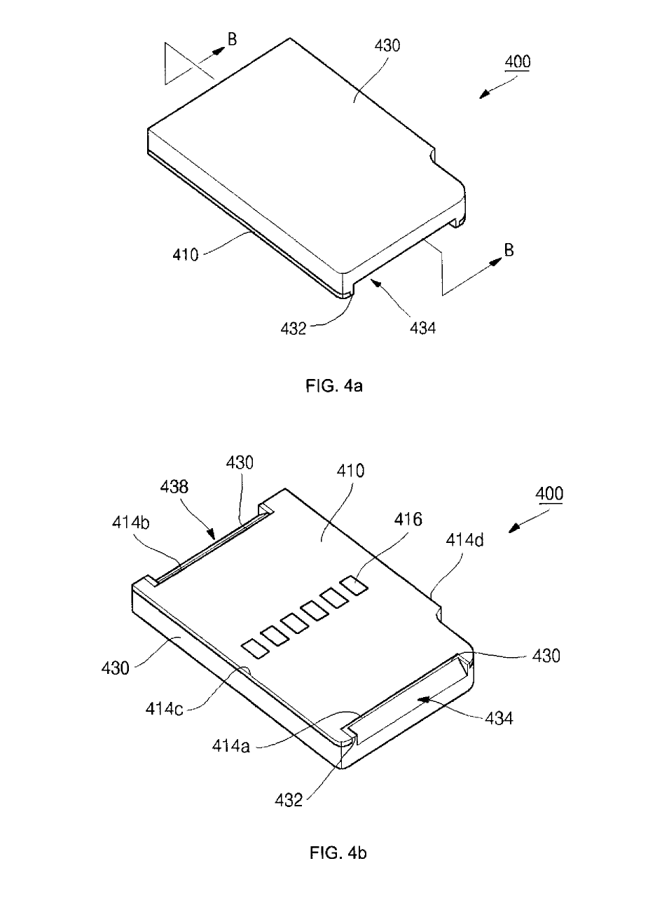

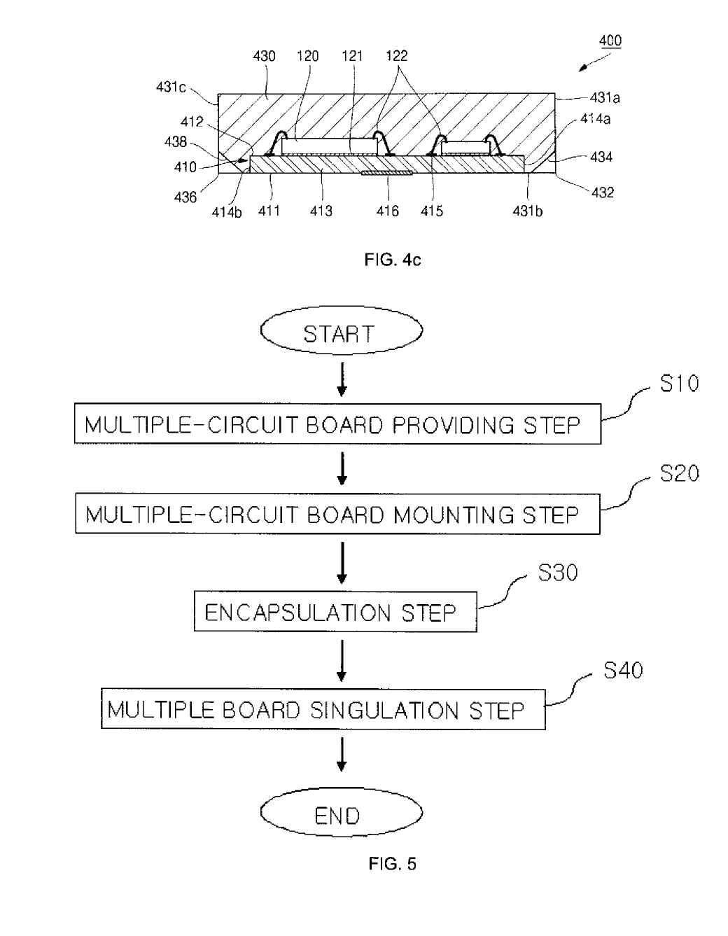

Referring now to FIGS. 4a-4c, there is shown a memory card 400 constructed in accordance with a fourth embodiment of the present invention. The memory card 400 of the fourth embodiment bears similarity in construction to the memory card 100 of the first embodiment, with the 400 series reference numerals in FIG. 4a-4c being used to identify the same structures identified by the corresponding 100 series reference numerals included in FIGS. 1a-1d. In this regard, only the distinctions between the memory cards 400, 100 will be discussed below.

In the memory card 400, the I/O pads 416 of the insulative layer 413 of the circuit board 410 extend in a single row located in approximately the center of the lower surface 411 of the insulative layer 413. Thus, in contrast to the I/O pads 116 in the memory card 100 which extend along and in close proximity to the front side 114a of the insulative layer 113, the I/O pads 416 of the memory card 400 are located substantially equidistantly between the front and back sides 414a, 414b of the insulative layer 413, and extend generally perpendicularly between the longitudinally extending sides 414c, 414d thereof.

In the memory card 400, the body 430 is formed to cover both the front side 414a and the back side 414b of the insulative layer 413. The body 430 defines a generally planar, laterally extending front side surface 431a which extends generally perpendicularly between opposed, generally planar top and bottom surfaces of the body 430, a corner 432 having an angle of approximately ninety degrees (90°) thus being defined between the front side 431a and the bottom surface 431b of the body 430. The body 430 further defines a generally planar, laterally extending back side surface 431c which extends generally perpendicularly between the opposed, generally planar top and bottom surfaces of the body 430, a corner 436 having an angle of approximately ninety degrees (90°) thus being defined between the back side 431c and the bottom surface 431b of the body 430.

Formed in the corner 432 of the body 430 is a first chamfer 434. The first chamfer 434 is substantially identical in shape to the above-described chamfer 134 of the memory card 100. In the regard, the preferred width of the chamfer 434 is roughly equal to the distance separating the outermost sides of the outermost pair of the I/O pads 416. In addition to the first chamfer 432, the memory card 400 includes a second chamfer 438 which is formed in the corner 436 of the body 430 and has substantially the same shape as the first chamfer 434. As such, the preferred width of the second chamfer 438 is also roughly equal to the distance separating the outermost sides of the outermost pair of the I/O pads 416. Due to the inclusion of the first and second chamfers therein and the orientation of the I/O pads 416, the memory card 400 can be mounted to an external device in any of forward and backward directions, and thus is well suited for use as an SID card. Those of ordinary skill in the art will recognize that in the memory card, the first and/or second chamfers 432, 438 may be substituted with sub-chamfers identical in shape to the sub-chamfers 234a, 334a described above in relation to the memory cards 200, 300.

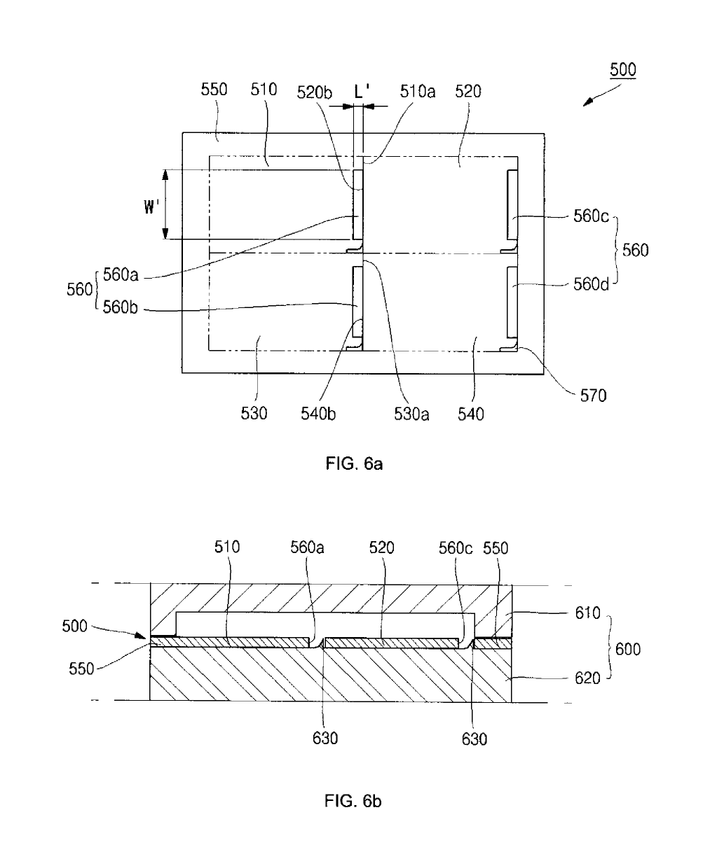

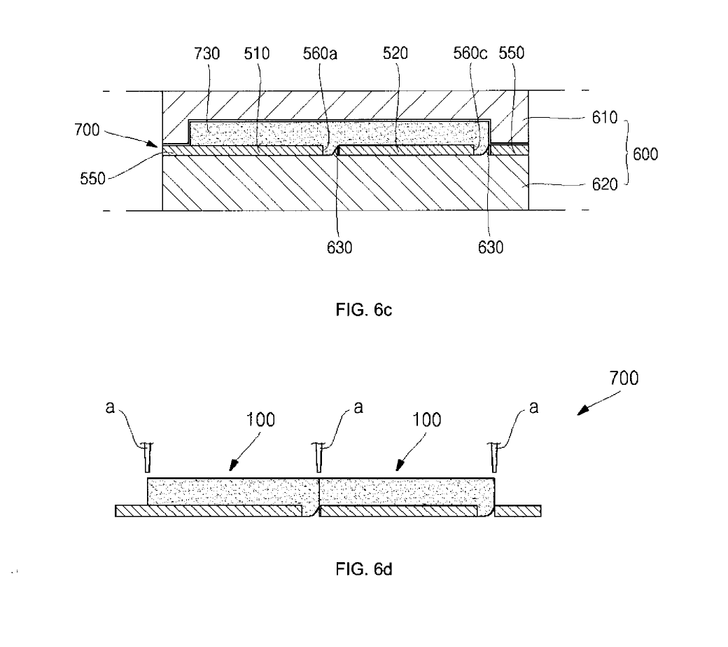

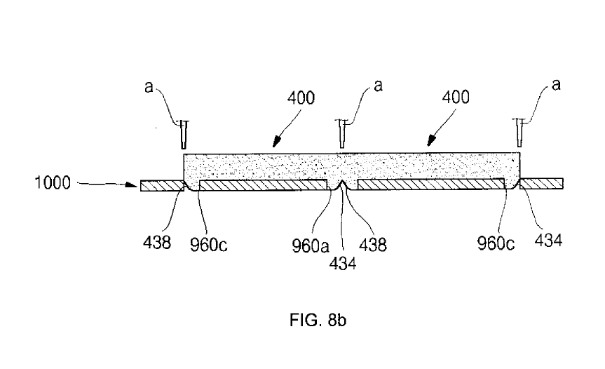

Referring now to FIG. 5, there is provided a flow chart setting forth an exemplary sequence of steps which may be used to facilitate the fabrication the memory cards 100, 200, 300, 400 of the present invention. The various steps highlighted in FIG. 5 will be discussed with particularity in relation to FIGS. 6a-6d which illustrate an exemplary sequence of steps for use in facilitating the fabrication of the memory card 100, and FIGS. 8a-8b which illustrate an exemplary sequence of steps for use in facilitating the fabrication of the memory card 400.

Referring now to the manufacturing methodology depicted in FIGS. 6a-6d, in the multiple circuit board providing step S10 of FIG. 5, a substrate 500 is initially provided which, when ultimately singulated, will define multiple circuit boards. More particularly, as seen in FIG. 6a, the substrate 500 includes four integral circuit boards 510, 520, 530, 540 which contact each other and are circumvented by a peripheral outer frame portion 550 of the substrate 500. The substrate 500 has a generally quadrangular (e.g., rectangular) configuration, and has a plurality of elongate through holes 560 formed therein. The through holes 560 are arranged as a first set of holes 560a, 560b which are disposed in the approximate center of the substrate 500, and a second set of holes 560c, 560d which are offset toward the right lateral side or edge of the substrate 500. Thus, the hole 560a is disposed between the laterally extending first side surface 510a of the circuit board 510 and the laterally extending second side surface 520b of the circuit board 520. Similarly, the hole 560b is disposed between the laterally extending first side surface 530a of the circuit board 530 and the laterally extending second side surface 540b of the circuit board 540. The holes 560c, 560d are disposed between the circuit boards 520, 540, respectively, and a corresponding side of the outer frame portion 550 of the substrate 500.

As will be recognized, the through holes 560 are formed in regions of the substrate 500 corresponding to the desired location of the chamfers 134 in each of the four memory cards 100 which will ultimately be fabricated to include respective ones of the circuit boards 510, 520, 530 and 540 singulated from the common substrate 500. Thus, the holes 560 each preferably have a width W′ (as shown in FIG. 6a) which generally corresponds to the width W of the chamfer 134 shown in FIG. 1b, and a length L′ (also shown in FIG. 6a) generally corresponding to the length L shown in FIG. 1c.

Subsequent to the formation of the through holes 560 in the substrate 500, electronic circuit devices 120 are mounted to each of the four integral circuit boards 510, 520, 530, 540 of the substrate 500. In this regard, though not shown in FIG. 6a, each circuit board 510, 520, 530, 540 includes the conductive pattern 115, conductive vias 115a and I/O pads 116 shown in FIG. 1c, with the mounting of electronic circuit devices 120 to the circuit boards 510, 520, 530, 540 through the use of the adhesive layers 121 and conductive wires 122 being accomplished such that the arrangement and electrical connection of the electronic circuit devices 120 to the circuit boards 510, 520, 530, 540 generally mirrors the arrangement shown in FIG. 1c.

Subsequent to the mounting of the electronic circuit devices 120 to the circuit boards 510, 520, 530, 540 of the substrate 500, the multiple circuit board mounting step S20 of FIG. 5 is completed wherein the substrate 500 is mounted within a mold 600 as seen in FIG. 6b for the completion of the subsequent encapsulation step S30 of FIG. 5. The preferred mold 600 includes an upper mold 610 and a lower mold 620. The substrate 500 is mounted between the upper and lower molds 610, 620 in the manner shown in FIG. 6b. The upper mold 610, and in particular the mold cavity defined thereby, has a shape generally corresponding to the bodies 130 of the memory cards 100 that will ultimately be fabricated to include respective ones of the circuit boards 510, 520, 530, 540. The substrate 500 is preferably sized relative to the mold 600 such that the outer frame portion 550 of the substrate 500 is captured between the upper and lower molds 610, 620 when the substrate 500 is properly interfaced thereto.

The lower mold 620 of the mold 600 defines a generally planar top surface which includes a plurality of protrusions 630 projecting upwardly therefrom. More particularly, four protrusions 630 are included on the lower mold 620, with each protrusion 630 projecting upwardly into a respective one of the holes 560 in the manner shown in FIGS. 6b and 6c. As will be recognized by those of ordinary skill in the art, the shape of each protrusion 630 corresponds to the ultimate shape or contour of the chamfer 134 of each memory card 100 fabricated to include a respective one of the circuit boards 510, 520, 530, 540. In this regard, it is contemplated that each protrusion 630 may be formed to be of any one of various shapes, depending on the desired final shape or contour for the chamfer 134 included on each resultant memory card 100. For example, each protrusion 630 may be shaped to ultimately define the chamfer 134 shown in FIG. 1b, or the sub-chamfers shown in FIGS. 2b and 3b.

In the encapsulation step S30 of FIG. 5, an encapsulant material having the above-described fillers 130b dispersed within a resin 130a is inserted into the mold cavity of the mold 600 in the manner shown in FIG. 6c. Such insertion of the encapsulant material into the mold cavity of the mold 600 may be accomplished through the implementation of, for example, an injection molding process or a transfer molding process. In the transfer molding process, the resin 130a component of the molding compound may be a thermo-set material, whereas in the injection molding process, the resin 130a component of the molding compound may be a low temperature thermo-set material or a thermo-plastic material. Typically, thermo-set materials demonstrate high reliability levels, though not necessarily being well suited for making certain shapes. Though thermo-plastic materials are better suited for making a wider range of shapes, the reliability level of such materials typically falls below that of thermo-set materials. Generally, transfer molding techniques are employed in the semiconductor industry for fabricating semiconductor packages due to such packages needing to achieve or meet certain reliability levels. As a result of the insertion of the encapsulant material into the mold cavity of the mold 600, the encapsulant material covers those surfaces of the substrate 500 which are not compressed between the upper and lower molds 610, 620 and are not in direct, abutting contact with the lower mold 620. As will be recognized, the encapsulant material covers the electronic circuit devices 120 electrically connected to the circuit boards 510, 520, 530, 540, in addition to the conductive wires 122 used to facilitate such electrical connection. The encapsulant material also flows through the holes 560, and thus comes into direct contact with the protrusions 630 in the manner also shown in FIG. 6c.

Upon the completion of the encapsulation step S30, a subassembly 700 is removed from within the mold 600, the subassembly 700 comprising the combination of the substrate 500 and the hardened encapsulant material. Upon the removal of this subassembly 700 from the mold 600, the multiple board singulation step S40 of FIG. 5 is completed in a manner shown in FIG. 6d. More particularly, saw blades (a) are preferably used to saw or singulate the substrate 500 along those lines shown in phantom in FIG. 6a, such sawing or singulation effectively separating the circuit boards 510, 520, 530, 540 from each other, and facilitating the fabrication of four separate memory cards 100. As will be recognized, during this sawing or singulation process, a saw blade (a) necessarily passes through the layer of hardened encapsulant material. Advantageously, due to the inclusion of the protrusions 630 in the mold 600 and flow of the encapsulant material thereagainst in the encapsulation step S30, no procedures need be taken subsequent to the completion of the singulation step S40 to facilitate the formation of the chamfers 134 in the completed memory cards 100.

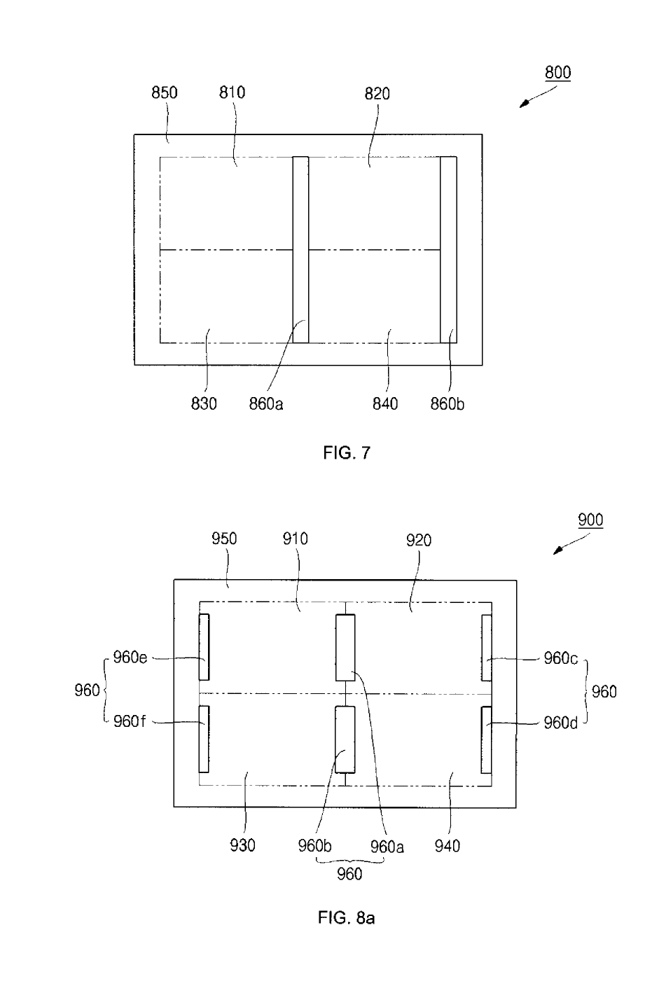

Referring now to FIG. 7, there is shown a substrate 800 which may be used as an alternative to the above-described substrate 500 in a process for simultaneously fabricating multiple memory cards 100 in accordance with the steps shown in FIGS. 6a-6d. The substrate 800 includes four integral circuit boards 810, 820, 830, 840 which contact each other and are circumvented by a peripheral outer frame portion 850 of the substrate 800. The substrate 800 has a generally quadrangular (e.g., rectangular) configuration, and has elongate through holes 860a, 860b formed therein. The hole 860a is disposed in the approximate center of the substrate 800, with the hole 860b being offset toward the right lateral side or edge of the substrate 800. As will be recognized, if the substrate 800 is employed in the fabrication methodology for the memory cards 100 as an alternative to the substrate 500, it is contemplated that the lower mold 620 of the mold 600 will be slightly structurally modified such that each memory card 100 formed as a result of the use of the substrate 800 will have the same general structural attributes described above.

Referring now to the manufacturing steps depicted in FIGS. 8a and 8b which are related to the fabrication of the memory card 400, a substrate 900 is initially provided which, when ultimately singulated, will define multiple circuit boards. More particularly, as seen in FIG. 8a, the substrate 900 includes four integral circuit boards 910, 920, 930, 940 which contact each other and are circumvented by a peripheral outer frame portion 950 of the substrate 900. The substrate 900 has a generally quadrangular (e.g., rectangular) configuration, and has a plurality of elongate through holes 960 formed therein. The through holes 960 are arranged as a first set of holes 960a, 960b which are disposed in the approximate center of the substrate 900, and a second set of holes 960c, 960d which are offset toward the right lateral side or edge of the substrate 900. Also included is a third set of holes 960e, 960f which are offset toward the left lateral side or edge of the substrate 900. As will be recognized, the holes 960 are formed in regions of the substrate 900 corresponding to the desired locations of the first and second chamfers 434, 438 in each of the four memory cards 400 which will ultimately be fabricated to include respective ones of the circuit boards 910, 920, 930 and 940 singulated from the common substrate 900. In this respect, as seen in FIG. 8a, the holes 960a, 960b are each approximately twice the width of the holes 960c, 960d, 960e, 960f since the hole 960a used to facilitate the creation of both the first chamfer 434 on the memory card 400 including the circuit board 910 and the second chamfer 438 on the memory card 400 including the circuit board 920. Similarly, the hole 960b used to facilitate the creation of both the first chamfer 434 on the memory card 400 including the circuit board 930 and the second chamfer 438 on the memory card 400 including the circuit board 940.

Subsequent to the formation of the through holes 960 therein, the substrate 900 is subjected to the electronic circuit device attachment, mold mounting, and encapsulation steps described above in relation to the sequence of steps for fabricating the memory cards 100. As will be recognized, the lower mold of the mold into which the substrate is mounted differs from the above-described lower mold 620 due to its inclusion of six protrusions which are arranged to project upwardly into respective ones of the holes 960 of the substrate 900. As seen in FIG. 8b, upon the completion of the encapsulation step, a subassembly 1000 is removed from within the mold, the subassembly 1000 comprising the combination of the substrate 900 and the hardened encapsulant material. Upon the removal of this subassembly 1000 from the mold, the multiple board singulation step is completed, with saw blades (a) being used to saw or singulate the substrate 900 along those lines shown in phantom in FIG. 8a, such sawing or singulation effectively separating the circuit boards 910, 920, 930, 940 from each other, and facilitating the fabrication of four separate memory cards 400. As will be recognized, during this sawing or singulation process, a saw blade (a) necessarily passes through the layer of hardened encapsulant material. Advantageously, due to the inclusion of the six protrusions in the mold used to fabricate the memory cards 400 and the flow of the encapsulant material thereagainst in the encapsulation step, no procedures need be taken subsequent to the completion of the singulation step to facilitate the formation of the first and second chamfers 434, 438 in the completed memory cards 400.

This disclosure provides exemplary embodiments of the present invention. The scope of the present invention is not limited by these exemplary embodiments. Numerous variations, whether explicitly provided for by the specification or implied by the specification, such as variations in structure, dimension, type of material and manufacturing process, may be implemented by one skilled in the art in view of this disclosure.

1. A memory card comprising:
a circuit board including an insulative layer having at least one I/O pad formed thereon and defining opposed front and back sides;
at least one electronic circuit device mounted to the circuit board and electrically connected to the I/O pad; and
a body covering the electronic circuit device and a portion of the circuit board such that the I/O pad is uncovered by the body and at least the front side of the insulative layer is covered thereby, the body including:
a top surface;
a bottom surface;
a front side surface which extends between the top and bottom surfaces in close proximity to the front side of the insulative layer, the front side and bottom surfaces being separated by a front corner; and
a chamfer which is formed in at least a portion of the front corner and extends at a prescribed angle relative to the front side and bottom surfaces of the body.

2. The memory card of claim 1 wherein the body is fabricated from an encapsulant material comprising a resin having spherical fillers distributed therein and extending to the chamfer.

3. The memory card of claim 1 wherein the insulative layer includes a plurality of I/O pads which extend along and in close proximity to the front side of the insulative layer.

4. The memory card of claim 3 wherein:
the I/O pads include an outer pair which are separated from each by a prescribed distance; and
the chamfer has a width which is not less than the prescribed distance separating the outer pair of the I/O pads from each other.

5. The memory card of claim 3 wherein the chamfer comprises a plurality of sub-chamfers which are generally aligned with respective ones of the I/O pads.

6. The memory card of claim 5 wherein:
each of the I/O pads is of a prescribed width; and
each of the sub-chamfers has a maximum width which is not less than the prescribed width of each of the I/O pads.

7. The memory card of claim 5 wherein each of the sub-chamfers has a generally quadrangular configuration when viewed from the front side surface of the body.

8. The memory card of claim 7 wherein each of the sub-chamfers is of gradually decreasing width from the front side surface of the body toward a respective one of the I/O pads.

9. The memory card of claim 5 wherein each of the sub-chamfers has a generally triangular configuration when viewed from the front side surface of the body.

10. The memory card of claim 1 wherein the body further covers the back side of the insulative layer and includes:
a back side surface which extends between the top and bottom surfaces in close proximity the back side of the insulative layer, the back side and bottom surfaces being separated by a back corner; and
a second chamfer which is formed in a least a portion of the back corner and extends at a prescribed angle relative to the back side and bottom surfaces of the body.

11. The memory card of claim 10 wherein the insulative layer includes a plurality of I/O pads which are each disposed in substantially equidistantly spaced relation to the front and back sides of the insulative layer.

12. The memory card of claim 10 wherein the chamfer and the second chamfer are identically configured to each other.

13. (canceled)

14. (canceled)

15. (canceled)

16. (canceled)

17. (canceled)

18. (canceled)

19. (canceled)

20. A memory card for use in conjunction with a device defining a socket which includes a plurality of connection terminals, the memory card comprising:
a circuit board including an insulative layer having at least one I/O pad formed thereon and defining opposed front and back sides;
at least one electronic circuit device mounted to the circuit board and electrically connected to the I/O pad; and
a body covering the electronic circuit device and a portion of the circuit board such that the I/O pad is uncovered by the body and at least the front side of the insulative layer is covered thereby, the body including:
a top surface;
a bottom surface;
a front side surface which extends between the top and bottom surfaces in close proximity the front side of the insulative layer, the front side and bottom surfaces being separated by a front corner; and
a means which is formed in at least a portion of the front corner for minimizing potential damage to the connection terminals during the process of advancing the memory card into the socket of the device.

21. A memory card comprising:
a circuit board including at least one I/O pad and defining opposed front and back sides;
at least one electronic circuit device disposed on the circuit board and electrically connected to the I/O pad; and
a body covering the electronic circuit device and at least the front side of the circuit board, the body including a bottom surface and a front side surface, at least portions of the front side and bottom surfaces being separated from each other by a beveled edge which extends at a prescribed angle relative thereto.

22. The memory card of claim 21 wherein the body further includes a top surface, and the front side surface extends generally perpendicularly between the top and bottom surfaces.

23. The memory card of claim 21 wherein the circuit board includes a plurality of I/O pads which extend along and in close proximity to the front side thereof.

24. The memory card of claim 23 wherein:
the I/O pads include an outer pair which are separated from each by a prescribed distance; and
the beveled edge has a width which is not less than the prescribed distance separating the outer pair of the I/O pads from each other.

25. The memory card of claim 21 wherein the body further covers the back side of the circuit board and includes a back side surface, at least portions of the back side and bottom surfaces being separated from each other by a second beveled edge which extends at a prescribed angle relative thereto.

26. The memory card of claim 25 wherein the body further includes a top surface, and the front and back side surfaces each extend generally perpendicularly between the top and bottom surfaces.

27. The memory card of claim 25 wherein the circuit board includes a plurality of I/O pads which are each disposed in substantially equidistantly spaced relation to the front and back sides thereof.
